(19) United States
(12) Patent Application Publication
(10) Pub. No.: US 2020/0290913 A1
(43) Pub. Date: Sep. 17, 2020

(54) Removal Of Bubbles From Molten Glass

(71) Applicant: Iowa State University Research Foundation, Inc., Ames, IA (US)

(72) Inventors: Steve w. Martin, Ames, IA (US); Ryan s. Gebhardt, Lehi, UT (US); Steven Kmiec, Ames, IA (US); Jose Ezequiel De Sousa, Dourados (BR); Seila Rojas De Sousa, Dourados (BR)

(21) Appl. No.: 16/873,278

(22) Filed: Mar. 10, 2020

Related U.S. Application Data
(60) Provisional application No. 62/919,520, filed on Mar. 15, 2019.

(51) Int. Cl. C03B 5/225; C03C 3/16; C03C 3/32

(52) U.S. Cl. CPC C03B 5/2252; H01M 10/0562; C03C 3/328; C03C 3/16

(57) ABSTRACT

A method for removing bubbles from molten glass is provided and involves subjecting the surface of the molten glass to at least one fining sequence wherein the fining sequence comprises subjecting the surface of the molten glass to a sub-atmospheric pressure (relative vacuum less one atmosphere of pressure) for a time followed by subjecting the surface of the molten glass to super-atmospheric gas pressure (greater than one atmosphere of pressure) for additional time. The fining sequence can be repeated as needed to produce a high quality optically clear glass that is substantially free of bubbles.

### CONTRACTUAL ORIGIN OF THE INVENTION

The invention was made with government support under Grant Nos. DE-AR0000778 and DE-AR0000654 awarded by the Department of Energy. The government has certain rights in the invention.

### FIELD OF THE INVENTION

The present invention involves a method for removing bubbles from molten glass, especially molten nitrogen-containing glasses.

### BACKGROUND OF THE INVENTION

Removal of bubbles (commonly known as fining) from molten glass of various glass types has been an ongoing problem over many decades. Various techniques such as chemical fining, thermal fining, and vacuum fining have been employed or investigated over the years for bubble removal. Vacuum fining is described in U.S. Pat. No. 3,622,296.

The introduction of nitrogen into glass compositions by ammonolysis, sputtering, or other means can improve chemical and electrochemical stability and performance in many applications. For example, addition of nitrogen to oxide and oxy-sulfide glasses can improve the chemical stability of the glasses. One method to add nitrogen is through ammonolysis in which ammonia gas is passed through a chamber containing the molten glass at an elevated temperature below its decomposition temperature. The ammonia reacts with oxygen in the molten glass in a manner to incorporate nitrogen into the glass and release water as a reaction product. The water is often retained in the solid glass as gas bubbles that adversely affect the optical clarity and other properties of the glass.

Certain phosphate-containing glasses based on the phosphate tetrahedron, such as alkali phosphate glasses, present problems with respect to vacuum fining in that heating of the phosphate glasses above about 800° C. results in the generation of toxic phosphine gas and in that heating of such glass to a temperature below this value while under vacuum is not sufficient to remove all of the bubbles from the liquid glass.

There is a need for an improved method for removing bubbles from molten glass in a manner to improve optical clarity and other properties and increase the yield of high quality (bubble-free) glass.

### SUMMARY OF THE INVENTION

Embodiments of the present invention provide a method for removing bubbles from molten glass that addresses this need.

An illustrative embodiment of the present invention involves subjecting the surface of the molten glass in a vessel to one or more fining processing sequences wherein each fining sequence comprises subjecting the surface of the molten glass to a sub-atmospheric pressure, such as less than one atmosphere of pressure (i.e. standard pressure), for a time followed by subjecting the surface of the molten glass to super-atmospheric gas pressure, such as greater than one atmosphere of pressure (i.e. standard pressure), for additional time wherein the pressurizing gas can be non-reactive or reactive with the molten glass. The fining sequence can be repeated as needed to produce a high quality glass that is substantially free of bubbles.

Embodiments of the present invention can be practiced for producing high quality glasses of various types and compositions that include, but are not limited to, nitrogen-containing glass compositions, glasses that contain a phosphate or other constituent that deleteriously decomposes upon heating to elevated temperature, glasses that contain both nitrogen and phosphate constituents and that can be used as solid glass electrolytes or separators, or both, in batteries.

These and other features and advantages of embodiments of the present invention will become more readily apparent from the following detailed description taken with the following drawings.

### BRIEF DESCRIPTION OF THE DRAWINGS

FIG. 1 is a schematic view of an illustrative vacuum furnace that can be used in practicing embodiments of the present invention.

FIG. 2(a) is a photograph of a LiPO₃ glass sample after initial base glass preparation, FIG. 2(b) is a photograph of the post-ammonolysis LiPO_{2.28}N_{0.48} sample after NH₃ flow at 780° C./6 h and containing bubbles, and FIG. 2(c) is a photograph of the bubble-free LiPO_{2.28}N_{0.48} glass sample after 3 fining sequences conducted pursuant to an embodiment of the present invention.

### DETAILED DESCRIPTION OF THE INVENTION

Practice of an illustrative embodiment of the present invention involves subjecting the surface of the molten glass in a vessel to one or more fining processing sequences. Each fining sequence comprises subjecting the surface of the molten glass to a sub-atmospheric pressure, such as less than one atmosphere of pressure (i.e. standard pressure), for a time followed by subjecting the surface of the molten glass to super-atmospheric gas pressure, such as greater than one atmosphere of pressure (i.e. standard pressure), for additional time wherein the pressurizing gas can be non-reactive or reactive with the molten glass and wherein the fining sequence can be repeated as needed to produce a high quality glass that is substantially free of bubbles.

Although embodiments of the present invention will be described below for purposes of illustration with respect to certain alkali phosphate glasses that contain relatively high amount of nitrogen, practice of the present invention is not limited to these glass compositions. Embodiments of the present invention can be practiced with respect to other glass compositions and types to remove bubbles from the molten glass.

Such other glass compositions can include, but are not limited to, nitrogen-containing glass compositions, borate glasses, silicate glasses, germanate glasses, vanadate glasses, molybdate glasses, arsenate glasses, and any other glass composition from which bubbles need to be removed, especially glasses that contain a phosphate or other constituent that deleteriously decomposes upon heating to elevated temperature.

Certain oxy-thio-nitride mixed network former glasses described in application Ser. No. 15/732,036, US publication No. 2018/0069264A1, the teachings of which are incorporated herein by reference, can be subjected to fining pursuant to embodiments of the present invention. An exemplary oxy-thio-nitride glass composition comprises:

0.70 Na₂S+0.30[0.5P₂S_{4.25}N_{0.5}+0.5P₂O_{4.7}N_{0.2}]

The following Examples are offered to further illustrate but not limit the scope or practice of the invention:

### Experimental Procedure Demonstrated for Alkali Phosphate Glass Compositions:

### 1.1 Base Glass Preparation:

Metaphosphate compounds, such as LiPO₃ and NaPO₃ in glassy forms, were prepared by conventional melting and casting methods. Batches of 50 grams of glass were obtained by weighing the appropriate amounts of Li₂CO₃ (Sigma Aldrich ≥99.0%), Na₂CO₃ (Fischer Chemical ≥99.5%) and (NH₄)₂HPO₄ (Sigma Aldrich ≥98.0%) at the 50Li₂O-50P₂O₅ mol % and 50Na₂O-50P₂O₅ mol % compositions. The powders, previously well mixed with a mortar and pestle, were treated at 400° C. to release gases (NH₃, CO₂, and H₂O) by adding the powder in several steps to a platinum/gold (Pt 95 wt. %/Au wt.5%) crucible. A heat treatment at 600° C. for 30 minutes was conducted to complete calcination. Finally, the batch was melted at 800° C. for 1 hour in a vitreous carbon crucible in a vertical tube furnace using several homogenizations by agitating the melt. The melt then was poured on a stainless-steel mold preheated at 260° C. and 220° C. for LiPO₃ and NaPO₃, respectively, and annealed at this temperature for 3 hours.

### 1.2 Ammonolysis Procedure:

The previously prepared glasses, LiPO₃ and NaPO₃, can be nitrated by melting under ammonia flow. The ammonolysis system used to prepare the material consisted of a Barnstead Thermoline 79400 tube furnace with controlled flows of N₂ and/or NH₃. During the initial heating process, an N₂ flow (290±20 mL/min) was used. After the furnace stabilized at temperatures defined between 750° C. and 780° C., the nitrogen is turned off and ammonia flow (160±40 mL/min) is turned on for a specific time (0.5-6 hours). Finally, the gas flow is again switched back to N₂ while the sample cools to room temperature. The nitridation is obtained by the following reaction:

(Li/Na)PO₃+xNH₃→(Li/Na)PO_{[3-(3x/2)]}Nₓ+(3x/2)H₂O (1)

Since the nitrogen is incorporated by a diffusive process, the glass samples presented a saturation concerning N incorporation into the glass structure as a function of mass and/or time. Bubble formation is also inherent to the ammonolysis process according to equation (1). As N is incorporated into the glass structure, the viscosity of the liquid starts to increase, and the water vapor produced forms bubbles that are not able to fine out at the higher viscosity. However, such nitrided glasses cannot be heated to temperatures higher than 800° C. in order to avoid the decomposition of the nitride compounds by the formation of phosphine, PH₃. This fact, added to the increase in viscosity, makes it difficult to reprocess these samples by the conventional melting process under an inert atmosphere in order to eliminate the bubbles, especially when a high amount of N [x≥0.25 of equation (1) above] has been incorporated.

### 1.3 Fining Processing Sequence Pursuant to Certain Embodiments of the Invention:

Solid samples of the nitrided glasses, LiPON and NaPON, made as described above, with x higher than 0.25, were re-melted in vitreous carbon crucibles and subjected to a fining processing sequence pursuant to certain embodiments of the invention to obtain high quality and bubble free samples.

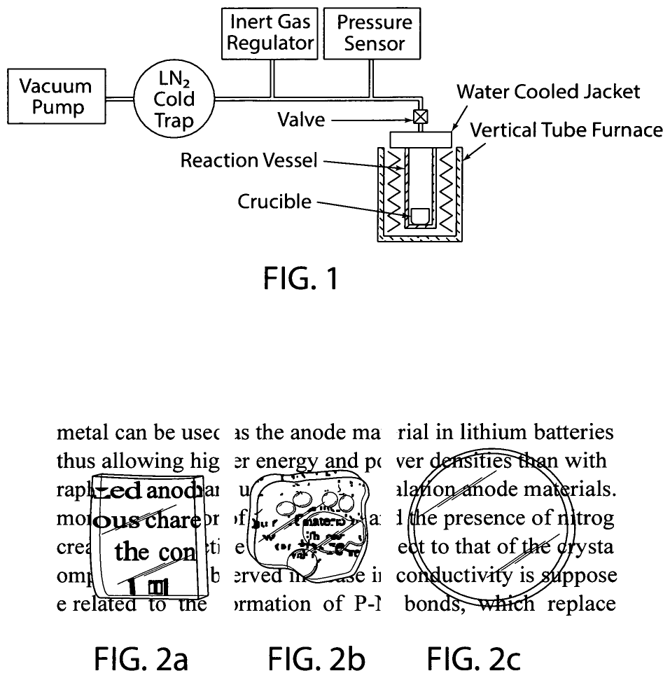

The fining system consisted of a vertical tube furnace, FIG. 1, having a reaction vessel in which a crucible is disposed and heated by heater (shown by zig-zag lines) and which is communicated to a vacuum pump (Chemstar 1376N vacuum pump) via a valve and a LN₂ cold trap and also to a source of nitrogen (N₂) such as a nitrogen gas cylinder and associated inert gas pressure regulator. A pressure sensor is provided downstream of the pressure regulator and upstream of the valve and a water-cooled jacket. The fining processing sequence involved two steps, which can be repeated as needed to obtain substantially bubble-free glass.

Initially, in a first step of an illustrative sequence, the glass samples in bulk form or powder form were melted under relative vacuum (sub-atmospheric pressure) in the range of 10 to 1000 mTorr (e.g. about 10⁻⁴ bar) in the crucible for different times in the range of 10 to 300 minutes (e.g. 180 minutes), depending on the x value (equation 1) of the glass composition, at temperatures up to 780° C., in the range from 650 to 800° C. (e.g. 760° C.). After being melted under relative vacuum for a sufficient enough time to allow bubbles to rise to the surface of the molten glass, the vacuum was turned off. Then, in a second step of the illustrative sequence, N₂ (or other gas) was turned on for a time in the range of 1 to 60 minutes (e.g. for 10 minutes), gradually increasing pressure on the surface of the molten glass in the furnace to a super-atmospheric pressure level in the range of 15 to 50 psia (e.g. 20 psia) effective to burst remaining (typically larger) bubbles at the surface of the molten glass. The illustrative fining sequence comprising vacuum application and N₂ pressure application to the molten glass surface was repeated 1 to 20 (e.g. 3) times. Under nitrogen pressure, the molten glass was observed to settle back into the vitreous carbon crucible and assume the shape of the crucible. Upon temperature quenching to ambient (room) temperature in the crucible, a bulk piece of glass with the same shape of the crucible was obtained.

The pressurizing gas employed in the bubble-bursting second step above one atmosphere of gas pressure can comprise a gas that is non-reactive with the molten glass (e.g. nitrogen) or a gas that may react with the molten glass, such as oxygen, water, sulfur dioxide, or other gas emitted by the molten glass in the furnace, or a reactive gas that is introduced into the furnace.

The initial vacuum melt step of the fining sequence was found to increase the glass transition temperature of the glass by about 20° C. as confirmed by DSC measurements for the LiPON samples after the initial vacuum melt step of the cycle. This increase can be attributed to the removal of incorporated moisture/hydroxyl groups trapped in the glass during the ammonolysis process.

Moreover, after the complete fining sequence was repeated 3 times, LiPON samples free of bubbles were obtained as shown in the right hand view, FIG. 2(c) as compared to the bubble-containing glass of FIG. 2(b). Similar advantageous results were achieved for the NaPON samples. The examples thus demonstrate production of high quality, optically clear alkali phosphate glass that is substantially free of bubbles. Practice of embodiments of the invention can improve the yield of such high quality glasses free of bubbles.

Such alkali phosphate glasses have several beneficial properties over other types of glasses such as silicate glasses and borate glasses. Such alkali phosphate glasses can find as solid glass electrolytes or solid glass separators, or both in batteries, such as secondary lithium batteries.

Mover, practice of embodiments of the present invention can produce glasses having improved optical quality and transparency together with improved mechanical and/or opto-mechanical properties and chemical durability that can find use, for example, as computer touch screens, mobile telephone touch screens, and the like.

Although the present invention has been described with respect to particular illustrative embodiments, those skilled in the art will appreciate that modifications and changes can be made thereto without departing from the spirit and scope of the invention as set forth in the appended claims.

We claim:

1. A method for fining molten glass, comprising subjecting a surface of molten glass to at least one fining sequence comprising subjecting the surface of the molten glass to a sub-atmospheric pressure followed by subjecting the surface of the molten glass to a super-atmospheric gas pressure.

2. The method of claim 1 wherein the sub-atmospheric pressure is in the range of 10 to 1000 mTorr.

3. The method of claim 2 wherein the sub-atmospheric pressure is present for a time of 10 to 300 minutes.

4. The method of claim 1 wherein the super-atmospheric gas pressure is in the range of 15 to 50 psia.

5. The method of claim 4 wherein the super-atmospheric gas pressure is applied for time of 1 to 60 minutes.

6. The method of claim 1 wherein the super-atmospheric gas pressure is applied by an inert gas, nitrogen gas, or other gas that is non-reactive with the molten glass.

7. The method of claim 1 wherein the fining cycle is repeated to produce a substantially bubble-free glass.

8. The method of claim 1 wherein the glass comprises a nitrogen-containing glass, a phosphate glass, a borate glass, a silicate glass, a germanate glass, a vanadate glass, a molybdate glass, or an arsenate glass.

9. The method of claim 8 wherein the phosphate glass comprises an alkali phosphate glass.

10. The method of claim 8 wherein the glass comprises an oxy-thio-nitride glass.

11. A solid glass that is substantially bubble-free made by the method of claim 1.
